(19) United States
(12) Patent Application Publication
(10) Pub. No.: US 2026/0359906 A1
(43) Pub. Date: Nov. 12, 2026

(54) LISTING DATA CREATION AND UPDATING

(71) Applicant: Commercial Real Estate Exchange, Inc., Playa Vista, CA (US)

(72) Inventors: Mark Roden, Sherman Oaks, CA (US); Oded Noy, Los Angeles, CA (US); Adrian Coroian, Playa Vista, CA (US); Andrew Jankowski, Playa Vista, CA (US); Eugene Reshetnikov, Aliso Viejo, CA (US)

(21) Appl. No.: 19/654,088

(22) Filed: Apr. 21, 2026

Related U.S. Application Data
(60) Provisional application No. 63/803,077, filed on May 9, 2025.

(51) Int. Cl. G06Q 50/163

(52) U.S. Cl. CPC G06Q 50/163

(57) ABSTRACT

For updating listing data, a method trains a property model that analyzes natural language property information. The method further receives reference data of property references, the reference data comprising at least one of web pages, offering memorandum, documents, emails, audio, video, and text. The method cross-references the reference data. The method analyzes the reference data using the property model to identify each property listing and each broker contact of the reference data. The method compares the reference data to listing data. In response to a given property listing of the reference data not being in listing data, the method adds the reference data to the listing data as a new property listing. In response to the given property listing differing from a corresponding property listing of the listing data, the method updates the corresponding property listing from the given property listing.

### CROSS-REFERENCE TO RELATED APPLICATIONS

This application claims priority to U.S. Provisional Patent Application No. 63/803,077 entitled “OMNI COMPARATIVE MARKET ANALYSIS” filed on May 9, 2025 for Mark Roden, which is incorporated herein by reference.

### BACKGROUND INFORMATION

The subject matter disclosed herein relates to updating listing data.

### BRIEF DESCRIPTION

A method for updating listing data is disclosed. The method trains a property model that analyzes natural language property information. The method further receives reference data of property references, the reference data comprising at least one of web pages, offering memoranda, documents, emails, audio, video, and text. The method cross-references the reference data. The method analyzes the reference data using the property model to identify each property listing and each broker contact of the reference data. The method compares the reference data to listing data. In response to a given property listing of the reference data not being in listing data, the method adds the reference data to the listing data as a new property listing. In response to the given property listing differing from a corresponding property listing of the listing data, the method updates the corresponding property listing from the given property listing. In response to the listing data comprising a first property listing that does not correspond to the reference data, the method deletes the first property listing. An apparatus and computer readable program product also perform the method.

### BRIEF DESCRIPTION OF DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic flow block diagram illustrating one embodiment of a listing data update system;

FIG. 2A is a schematic block diagram illustrating one embodiment of listing data;

FIG. 2B is a schematic block diagram illustrating one embodiment of broker data;

FIG. 2C is a schematic block diagram illustrating one embodiment of property references;

FIG. 2D is a schematic block diagram illustrating one embodiment of training data;

FIG. 3 is a schematic block diagram illustrating one embodiment of a generation/feedback cycle;

FIG. 4A is a schematic block diagram illustrating one embodiment of a computer;

FIG. 4B is a schematic block diagram illustrating one embodiment of a neural network;

FIG. 5A is a schematic flow chart diagram illustrating one embodiment of a listing data update method; and

FIG. 5B is a schematic flow chart diagram illustrating one embodiment of a model training method.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. The term “and/or” indicates embodiments of one or more of the listed elements, with “A and/or B” indicating embodiments of element A alone, element B alone, or elements A and B taken together.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

Program code for carrying out operations for aspects of the present invention may be written in any combination of one or more programming languages, including an object-oriented programming language such as MATLAB, Python, Ruby, R, Java, Java Script, Julia, Go, Smalltalk, C++, C sharp, Lisp, Clojure, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The computer program product may be shared, simultaneously serving multiple customers in a flexible, automated fashion.

The schematic flowchart diagrams and/or schematic block diagrams in the Figures illustrate the architecture, functionality, and operation of possible implementations. It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Although various arrow types and line types may be employed in the flowchart and/or block diagrams, they are understood not to limit the scope of the corresponding embodiments. Indeed, some arrows or other connectors may be used to indicate only an exemplary logical flow of the depicted embodiment.

The description of elements in each figure may refer to elements of proceeding figures. Like numbers refer to like elements in all figures, including alternate embodiments of like elements.

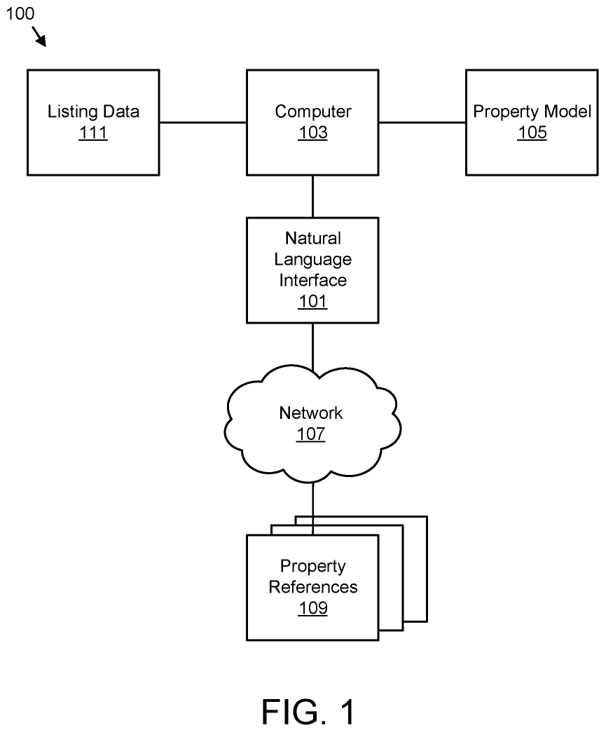

FIG. 1 is a schematic flow block diagram illustrating one embodiment of a listing data update system 100. In the depicted embodiment, the listing data update system 100 includes listing data 111, a computer 103, a property model 105, a natural language interface 101, a network 107, and property references 109. The listing data 111 is maintained for a plurality of properties. Information about the properties may periodically change. The system 100 identifies the changes and updates the listing data 111.

In one embodiment, the computer 103 searches for changes in information in property references 109 for the properties. The computer 103 may search in response to an email query, an interface query, a text query, a verbal query, and/or the expiration of a refresh time interval. A property reference 109 may be information on a webpage, offering memoranda, the contents of an email and/or text, audio, video, documents, a multiple listing service (MLS) entry, and the like. The computer 103 may access the property references 109 using the network 107. The network 107 may be the Internet, telephone network, a wide area network, a local area network, and the like.

In one embodiment, a natural language interface 101 is used to access the property references 109. The natural language interface 101 may interpret reference data in the property references 109. In addition, the natural language interface 101 may interpret navigation options that are presented in the property references 109. The computer 103 retrieves reference data from the property references 109.

The computer 103 may analyze the reference data using the property model 105. The property model 105 may be trained to analyze natural language property information such as the property references 109. In one embodiment, the property model 105 identifies properties and brokers in reference data of the property references 109. The identified properties and brokers may be used to update the listing data 111 as will be described hereafter. As a result, the listing data 111 is updated more regularly and with greater efficiency than is possible using human agents.

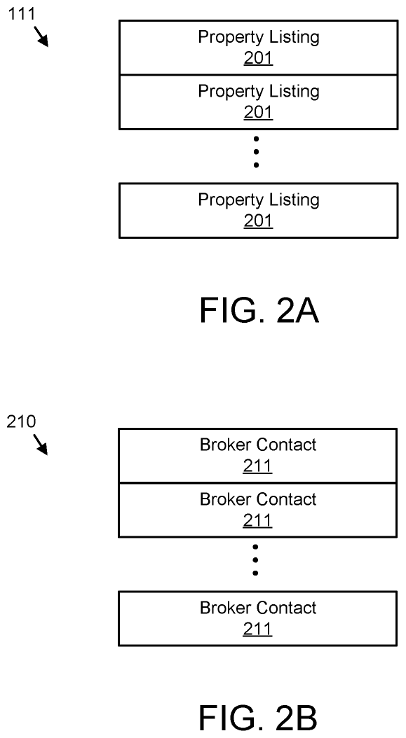

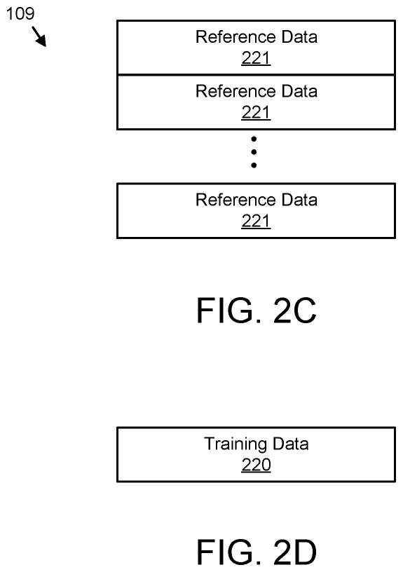

FIG. 2A is a schematic block diagram illustrating one embodiment of listing data 111. The listing data 111 may be organized as a data structure in a memory. In the depicted embodiment, the listing data 111 includes a plurality of property listings 201. Each property listing 201 may describe at least one property. In one embodiment, each property listing 201 comprises but is not limited to the elements in Table 1.

TABLE 1

Broker Contact 211
Property Address
Property Description
Completely automated public Turing test to tell
computers and humans apart (CAPTCHA) bypass
Manual setup
Universal resource locator (URL) forbidden
Images excluded (based on watermarking service)

FIG. 2B is a schematic block diagram illustrating one embodiment of broker data 210. The broker data 210 may be organized as a data structure in a memory. In the depicted embodiment, the broker data 210 includes a plurality of broker contacts 211. Each broker contact 211 may comprise but is not limited to the elements in Table 2.

TABLE 2

Broker Name
Broker Phone
Broker Email

FIG. 2C is a schematic block diagram illustrating one embodiment of the property references 109. The property references 109 comprise a plurality of reference data 221. The reference data 221 may comprise at least one of web pages, offering memoranda, documents, emails, audio, and text. In one embodiment, the reference data 221 comprises but is not limited to the elements of Table 3.

TABLE 3

Property Listing
Broker Contact
Web Pages
Offering memoranda
URL
Documents
Emails
Audio
Text

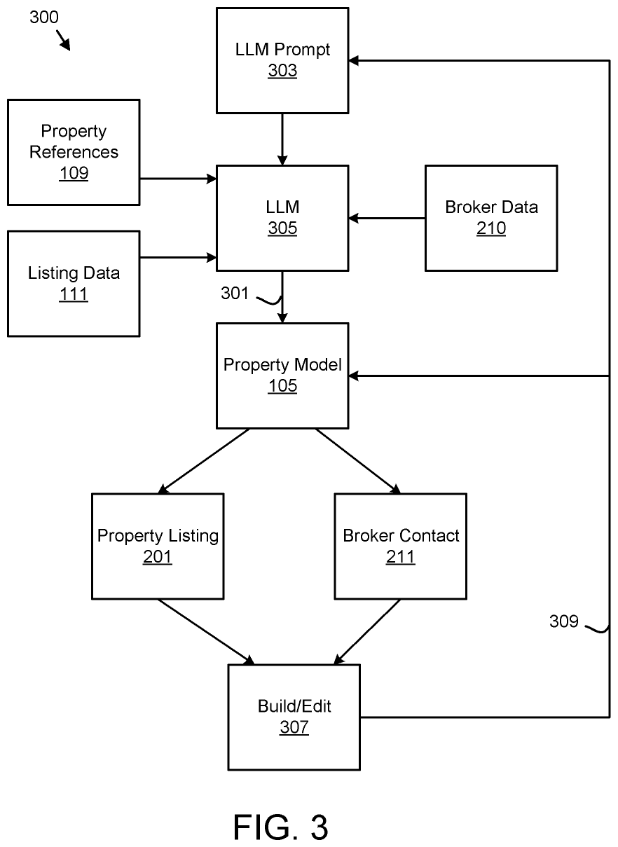

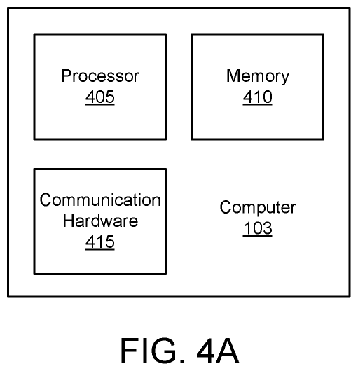

FIG. 2D is a schematic block diagram illustrating one embodiment of training data 220. The training data 220 may comprise at least one of the listing data 111, the property references 109, and the broker data 210. In one embodiment, the training data 220 may include data changes as will be described hereafter in FIG. 3.

FIG. 3 is a schematic block diagram illustrating one embodiment of a generation/feedback cycle 300 for the listing data update system 100. In the depicted embodiment, a large language model (LLM) 305 receives property references 109 including reference data 221, listing data 111 including property listings 201, and broker data 210 including broker contacts 211. In response to LLM prompts 303, the LLM 305 generates natural language property information 301. The LLM prompts 303 are tuned to extract the desired natural language property information 301 from the reference data 221, the property listings 201, and/or the broker contacts 211 using the LLM 305.

The property model 105 receives the natural language property information 301 and cross-references the reference data 221, the property listings 201, and/or the broker contacts 211. The property model 105 further analyzes the reference data 221, the property listings 201, and/or the broker contacts 211 to identify each property listing 201 and broker contact 211. The property model 105 further compares the property listing 201 and/or broker contact 211 to the listing data 111 and broker data 210.

The property model 105 generates and/or updates property listings 201 and/or broker contacts 211 from the reference data 221. In one embodiment, a user may generate a build/edit 307 on the generated and/or updated property listing 201 and/or broker contact 211. For example, the listing data update system 100 may receive an email that includes reference data 221. The LLM 305 may extract the desired natural language property information 301 from the reference data 221 in response to the LLM prompt 303. The property model 105 may generate a property listing 201 from the natural language property information 301. A user may complete elements of the property listing 201 as part of the build/edit 307. In a certain embodiment, the property listing 201 including the build/edit 307 may be completed in under 90 seconds. In addition, the build/edit 307 may be automated.

The build/edit 307 may alter an updated property listing 201 and/or broker contact 211. The difference between the original property listing 201 and/or broker contact 211 and the updated property listing 201 and/or broker contact 211 may analyzed by the property model 105 to determine data changes 309. The data changes 309 from the build/edit 307 may be used to update the LLM prompt 303 and/or or included in the training data 220 to train the property model 105. As a result, the generation/feedback cycle 300 is continuously improved.

In one embodiment, the data changes 309 modify the processing of property references 109 including reference data 221, listing data 111 including property listings 201, and broker data 210 including broker contacts 211 by the LLM 305, the computer 103, and/or the natural language interface 101. For example, the data changes 309 may be used to retrain the LLM 305. In addition, the data changes 309 may be used to modify parameters for the computer 103 and/or natural language interface 101.

In one embodiment, the data changes 309 comprise examples that would yield an updated property listing 201 and/or broker contact 211 as specified by the build/edit 307. The data changes 309 may be applied to the property model 105 as new training data 220. For example, the property model 105 may be updated and/or trained using the data changes 309. In addition, the data changes 309 may be applied to the LLM prompt 303 as limitations that yield the updated property listing 201 and/or broker contact 211.

Alternatively, the updated property listing 201 and/or broker contact 211 may be used to automatically change and/or update the LLM prompt 303 and/or the property model 105. For example, the updated property listing 201 and/or broker contact 211 may be used as training data 220 for the property model 105.

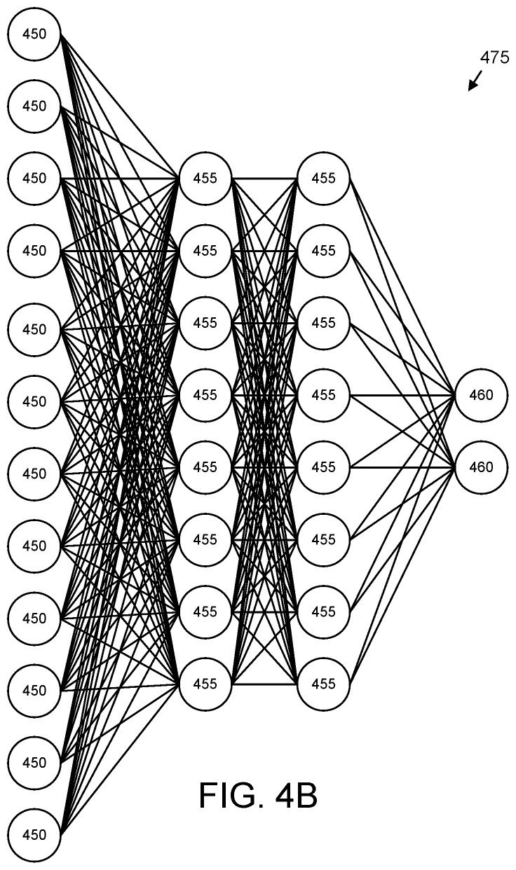

FIG. 4A is a schematic block illustrating one embodiment of the computer 103. In the depicted embodiment, the computer 103 includes a processor 405, a memory 410, and communication hardware 415. The memory 410 may store code and data. The processor 405 may execute the code and process the data. The communication hardware 415 may communicate with other devices.

FIG. 4B is a schematic block diagram illustrating one embodiment of a neural network 475. In the depicted embodiment, the neural network 475 includes input neurons 450, hidden neurons 455, and output neurons 460. The neural network 475 may be organized as a convolutional neural network, a recurrent neural network, long short term memory (LSTM) network, transformer, and the like.

The neural network 475 may be trained with training data 220 such as reference data 221. The neural network 475 may be trained using one or more learning functions while applying the training data 220 to the input neurons 450 and known result values to the output neurons 460.

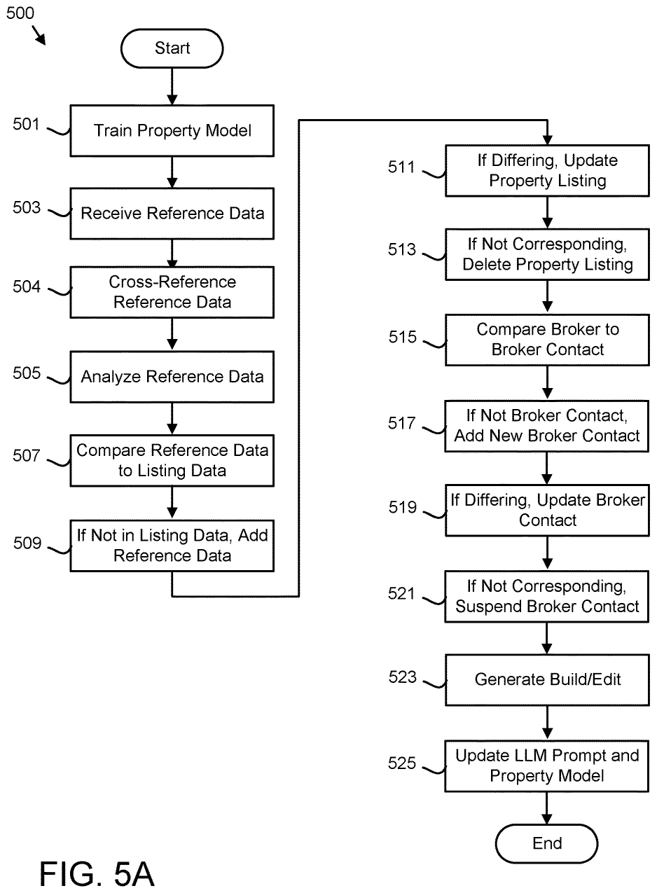

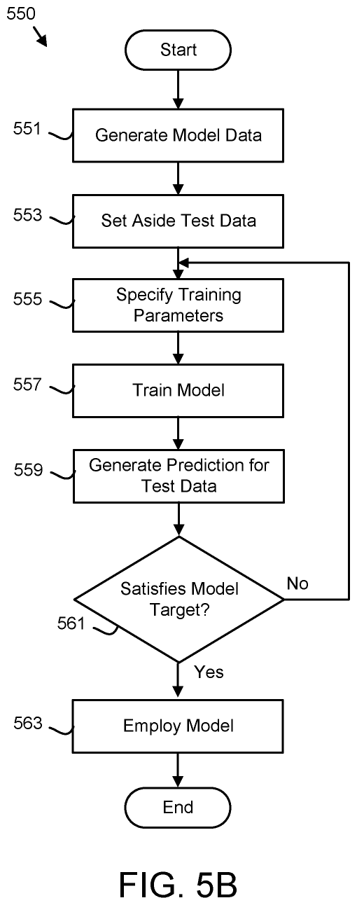

FIG. 5A is a schematic flow chart diagram illustrating one embodiment of a listing data update method 500. The method 500 may update the listing data 111 and/or the broker data 210. The method 500 may be performed by the listing data update system 100, the computer 103, the neural network 475, or combinations thereof.

The method 500 trains 501 the property model 105. The property model 105 may be trained 501 as described hereafter in FIG. 5B. In addition, training 501 may include but is not limited to defining, modifying, and/or updating the LLM prompt 303, defining, modifying, and/or updating a pipeline of element flows such as illustrated in FIG. 3, and defining, modifying, and/or updating the build/edit 307. The property model 105 may analyze natural language property information 301 including the reference data 221 of property references 109 and the broker contacts 211 of the broker data 210.

The method 500 receives 503 reference data 221 for property references 109. The reference data 221 may comprise at least one of web pages, offering memoranda, documents, emails, audio, video, and text. The reference data 221 may be received 503 through the network 107 and may be interpreted by the natural language interface 101.

In addition, the reference data 221 may be received 503 using optical character recognition (OCR) embodied in the natural language interface 101. The OCR reference data 221 may be interpreted by the natural language interface 101.

In one embodiment, the reference data 221 is received 503 via a user-submitted email. The email may describe a property or property reference 109, provide an address of the property or property reference 109, provide a URL for the property or property reference 109, and the like. The email may be interpreted by the natural language interface 101.

The method 500 may cross-reference 504 the reference data 221. The method 500 further analyzes 505 the reference data 221 using the property model 105. The property model may identify property listings 201 and/or broker contacts 211 from the reference data 221.

The method 500 compares 507 the reference data 221 to the listing data 111. In response to a given property listing 201 of the reference data 221 not being in the listing data 111, the method 500 adds 509 the reference data 221 to the listing data 111 as a new property listing 201.

In response to the given property listing 201 differing from a corresponding property listing 201 of the listing data 111, the method 500 updates 511 the corresponding property listing 201 from the given property listing 201.

In response to the listing data 111 comprising a first property listing 201 that does not correspond to the reference data 221, the method 500 deletes 513 the first property listing 201 from the listing data 111.

The method 500 compares 515 each broker contact 211 of the reference data 221 to the broker data 210. In response to a given broker contact 211 of the reference data 221 not being a broker contact 211 in the broker data 210, the method 500 adds 517 the given broker contact 211 to the broker data 210.

In response to the given broker contact 221 of the reference data 201 differing from a corresponding broker contact 211 of the broker data 210, the method 500 updates 519 the corresponding broker contact 211 from the given broker contact 211.

In response to the broker data 210 comprising a first broker contact 211 that does not correspond to a broker contact 211 in the reference data 221, the method 500 suspends 521 the first broker contact 211.

In one embodiment, the method 500 generates 523 the build/edit 307. A user may generate 523 the build/edit 307 in response to property listing 201 and/or broker contact 211. In a certain embodiment, the method generates 523 the build/edit 307 based on the property listing 201 and/or broker contact 211.

In one embodiment, the method 500 updates 525 the LLM prompt 303 and/or the property model 105 using the data changes 309 from the build/edit 307. The LLM prompt 303 and/or the property model 105 may be continuously updated using the data changes 309. In one embodiment, the property model 105 is retrained using the data changes 309. In addition, prompts and/or parameters of the property model 105 may be updated. The LLM prompt 303 may be modified based on the data changes 309 from the build/edit 307. For example, the LLM prompt 303 may be updated to prevent the need for specific data changes 309 from the build/edit 307.

FIG. 5B is a flow chart diagram illustrating one embodiment of a model training method 550. The method 550 may train the property model 105. The method 550 may be performed by the processor 405 and/or neural network 475.

The method 550 starts and in one embodiment, the method 550 generates 551 the training data 220. The training data 220 may be historic data. In one embodiment, real-time training data 220 is added.

The method 550 may set aside 553 a portion of the training data 220 as test data. The test data will not be used to train the property model 105.

The method 550 may specify 555 the training parameters. The property model 105 is trained 557 using the training data 220 in accordance with the training parameters.

The method 550 generates 559 a prediction from the property model 105 with the test data. The method 550 determines 561 whether the prediction satisfies a target for the property model 105. If the prediction does not satisfy the target, the training parameters are modified 555 and the property model 105 is again trained 557. If the prediction satisfies the target, the trained property model 105 is employed 563 and the method 550 ends.

The embodiments improve the efficiency, efficacy, and function of adding to and updating the listing data 111 and/or broker data 210. By employing the property model 105, the embodiments improve the efficiency of identifying novel information in reference data 221 and analyzing the reference data 221. As a result, the listing data 111 and/or broker data 210 is more efficiently added to. The embodiments further improve the efficacy of identifying novel information in reference data 221 and analyzing the reference data 221 and adding the novel information to listing data 111 and/or broker data 210 and/or updating and/or correcting the listing data 111 and/or broker data 210. The embodiments further improve the function of the listing data update system 100 by identifying new property listings 201 and/or broker contacts 211. The embodiments further improve the function of the listing data update system 100 by updating the existing property listings 201 and/or broker contacts 211.

This description uses examples to disclose the invention and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method comprising:
training, by use of a processor, a property model that analyzes natural language property information;
receiving reference data of property references, the reference data comprising at least one of web pages, offering memorandum, documents, emails, audio, video, and text;
cross-referencing the reference data;
analyzing the reference data using the property model to identify each property listing and each broker contact of the reference data;
comparing the reference data to listing data;
in response to a given property listing of the reference data not being in listing data, adding the reference data to the listing data as a new property listing;
in response to the given property listing differing from a corresponding property listing of the listing data, updating the corresponding property listing from the given property listing;
in response to the listing data comprising a first property listing that does not correspond to the reference data, deleting the first property listing;
comparing each broker contact of the reference data to broker data;
in response to a given broker contact of the reference data not being a broker contact in the broker data, adding the given broker contact to the broker data;
in response to the given broker contact differing from a corresponding broker contact of the broker data, updating the corresponding broker contact from the given broker contact; and
in response to the broker data comprising a first broker contact that does not correspond to a broker contact in the reference data, suspending the first broker contact.

2. The method of claim 1, further comprising receiving the natural language property information of the reference data from a large language model (LLM) provided with the reference data and an LLM prompt.

3. The method of claim 2, further comprising performing a build/edit on at least one of the property listing and the broker contact.

4. The method of claim 3, further comprising updating the LLM prompt with data changes from the build/edit.

5. The method of claim 3, further comprising training the property model using data changes from the build/edit.

6. The method of claim 1, wherein each property listing comprises but is not limited to a broker contact, a property address, a property description, a completely automated public Turing test to tell computers and humans apart (CAPTCHA) bypass, a manual setup, a universal resource locator (URL) forbidden, and images excluded.

7. The method of claim 1, wherein each broker contact comprises but is not limited to a broker name, a broker phone, and a broker email.

8. The method of claim 1, wherein each reference data comprises but is not limited to a property listing, a broker contact, a web page, a universal resource locator (URL), an offering memorandum, documents, emails, audio, and text.

9. The method of claim 1, wherein reference data is received using optical character recognition (OCR).

10. The method of claim 1, wherein the reference data is received via a user submitted email describing a property.

11. An apparatus comprising:
a processor executing code stored in a memory to perform:
training a property model that analyzes natural language property information;
receiving reference data of property references, the reference data comprising at least one of web pages, offering memorandum, documents, emails, audio, video, and text;
cross-referencing the reference data;
analyzing the reference data using the property model to identify each property listing and each broker contact of the reference data;
comparing the reference data to listing data;
in response to a given property listing of the reference data not being in listing data, adding the reference data to the listing data as a new property listing;
in response to the given property listing differing from a corresponding property listing of the listing data, updating the corresponding property listing from the given property listing;
in response to the listing data comprising a first property listing that does not correspond to the reference data, deleting the first property listing;
comparing each broker contact of the reference data to broker data;
in response to a given broker contact of the reference data not being a broker contact in the broker data, adding the given broker contact to the broker data;
in response to the given broker contact differing from a corresponding broker contact of the broker data, updating the corresponding broker contact from the given broker contact; and
in response to the broker data comprising a first broker contact that does not correspond to a broker contact in the reference data, suspending the first broker contact.

12. The apparatus of claim 11, the processor further receiving the natural language property information of the reference data from a large language model (LLM) provided with the reference data and an LLM prompt.

13. The apparatus of claim 12, the processor further performing a build/edit on at least one of the property listing and the broker contact.

14. The apparatus of claim 12, further comprising updating the LLM prompt with data changes from the build/edit.

15. The apparatus of claim 12, further comprising training the property model using data changes from the build/edit.

16. The apparatus of claim 11, wherein each property listing comprises but is not limited to a broker contact, a property address, a property description, a completely automated public Turing test to tell computers and humans apart (CAPTCHA) bypass, a manual setup, a universal resource locator (URL) forbidden, and images excluded.

17. The apparatus of claim 11, wherein each broker contact comprises but is not limited to a broker name, a broker phone, and a broker email.

18. The apparatus of claim 11, wherein each reference data comprises but is not limited to a property listing, a broker contact, a web page, a universal resource locator (URL), an offering memorandum, documents, emails, audio, and text.

19. A computer readable program product comprising a non-transitory computer medium storing code executed by a processor to perform:
training a property model that analyzes natural language property information;
receiving reference data of property references, the reference data comprising at least one of web pages, offering memorandum, documents, emails, audio, video, and text;
cross-referencing the reference data;
analyzing the reference data using the property model to identify each property listing and each broker contact of the reference data;
comparing the reference data to listing data;
in response to a given property listing of the reference data not being in listing data, adding the reference data to the listing data as a new property listing;
in response to the given property listing differing from a corresponding property listing of the listing data, updating the corresponding property listing from the given property listing;
in response to the listing data comprising a first property listing that does not correspond to the reference data, deleting the first property listing;
comparing each broker contact of the reference data to broker data;
in response to a given broker contact of the reference data not being a broker contact in the broker data, adding the given broker contact to the broker data;
in response to the given broker contact differing from a corresponding broker contact of the broker data, updating the corresponding broker contact from the given broker contact; and
in response to the broker data comprising a first broker contact that does not correspond to a broker contact in the reference data, suspending the first broker contact.

20. The computer readable program product of claim 19, the processor further receiving the natural language property information of the reference data from a large language model (LLM) provided with the reference data and an LLM prompt and the processor further performing a build/edit on at least one of the property listing and the broker contact.
